(19) United States
(12) Patent Application Publication
(10) Pub. No.: US 2024/0322648 A1
(43) Pub. Date: Sep. 26, 2024

(54) ELECTRIC MACHINE

(71) Applicant: MAGNA Powertrain GmbH & Co KG, Lannach (AT)

(72) Inventors: Attila Farkas, Budapest (HU); Attila Nyitrai, Wien (AT)

(21) Appl. No.: 18/578,808

(22) PCT Filed: Jul. 14, 2022
(86) PCT No.: PCT/EP2022/069737

§ 371 Date: Jan. 12, 2024

(30) Foreign Application Priority Data
Jul. 16, 2021 (DE) 10 2021 207 594.0

(51) Int. Cl. H02K 9/19; H02K 1/276; H02K 1/32; H02K 21/14

(52) U.S. Cl. CPC H02K 9/19; H02K 1/276; H02K 1/32; H02K 21/14

(57) ABSTRACT

An electric machine includes a fixed stator having a stator core on which stator windings are fixed and a rotor with a rotor core. The stator windings form winding heads on the end faces of the stator core. Multiple spaced-apart receiving regions are formed in the rotor core, into which permanent magnets are inserted and fixed via a fixing compound. A cooling system for cooling the rotor has at least one fluid channel via which cooling fluid is guided to the end faces of the rotor core. The fixing compound forms a ring on each of the end faces of the rotor core and is shaped such that the cooling fluid on the end faces is directed toward the winding heads during rotation.

### CROSS-REFERENCE TO RELATED APPLICATIONS

This application is a National Stage of International Application No. PCT/EP2022/069737, filed Jul. 14, 2022, which claims priority to DE 10 2021 207 594.0 filed Jul. 16, 2021. The entire disclosures of each of the above applications are incorporated herein by reference.

### FIELD

The present invention relates to an electric machine having a fixed stator, wherein the stator has a stator core on which stator windings are fixed, said stator windings forming winding heads on the end faces of the stator core, a rotor mounted rotatably in relation to the stator, wherein the rotor has a rotor core which is arranged fixedly on a rotor shaft and in which there are formed multiple circumferentially uniformly spaced-apart receiving regions into which in each case one permanent magnet is inserted and fixed via a fixing compound, and a cooling system for cooling the rotor, wherein the cooling system has at least one fluid channel via which cooling fluid is able to be guided to the end faces of the rotor core.

### BACKGROUND

This section provides information related to the present disclosure which is not necessarily prior art.

Electric machines of the above-stated type serve for conversion of electrical energy into mechanical energy and vice versa and are widely used as a motor and/or generator in the automotive engineering sector.

Electric machines comprise a fixed stator and a movable rotor, wherein, in the most common design of an electric machine, the rotor is mounted rotatably within an annular stator. The stator has a stator core and at least one stator winding which is arranged on the stator core and which forms on the end faces of the stator core in each case one winding head. The rotor has a rotor core arranged fixedly on a rotor shaft and has, in a common design of the rotor, circumferentially uniformly distributed permanent magnets arranged in or on said rotor core.

Electric machines generate heat owing to dielectric loss during their operation, wherein, owing to the dense arrangement of the current conductors, the winding head of an electric machine is in this case generally the hottest point, in particular due to the superposition of the phases of the coil winding in this region.

Excessively intense heating of a winding head results in an increase in the dielectric loss factor, whereby more electrical energy is converted into heat, which brings about a reduction in the efficiency of the electric machine, on the one hand, and has a negative influence on reliable operation of the electric machine over its service life, on the other hand. Therefore, in drive arrangements with electric machines, provision is generally made of a cooling apparatus which cools those parts of the electric machine which are to be cooled, in particular a winding head. Conventionally, a winding head is cooled through thermal connection of the winding head to the respective stator assembly, for emission of the heat losses that occur, and possibly to cooling apparatuses provided there (indirect cooling). Direct cooling of a winding head by means of for example oil, which is directly sprayed or directed onto the winding heads, is also known.

### SUMMARY

This section provides a general summary of the disclosure, and is not a comprehensive disclosure of its full scope or all of its features.

It is an object of the invention to present an electric machine which is distinguished by simple, component-optimized, direct winding-head cooling which permits cooling of a winding head that is as uniform and targeted as possible.

This need can be met by the subject matter of the present invention as described in the present disclosure. . . . Advantageous embodiments of the present invention are described herein.

The electric machine according to the invention serves in particular for use in a motor vehicle.

The electric machine according to the invention comprises a fixed stator, a rotor mounted rotatably in relation to the stator, and a cooling system for cooling the rotor.

According to the invention, the stator has a stator core on which stator windings are fixed, said stator windings forming winding heads on the end faces of the stator core.

According to the invention, the rotor has a rotor core which is arranged fixedly on a rotor shaft and in which there are formed multiple circumferentially uniformly spaced-apart receiving regions into which in each case one permanent magnet is inserted and fixed via a fixing compound.

According to the invention, the cooling system has at least one fluid channel via which cooling fluid is able to be guided to the end faces of the rotor core.

According to the present invention, the fixing compound is at least partially formed in such a way that it forms a ring on each of the end faces of the rotor core of the rotor.

According to the invention, the respective ring is shaped in such a way that, during rotation of the rotor, the cooling fluid on the end faces of the rotor core is in each case directed toward the winding heads of the stator. For example, the ring has a bevel in the direction of the winding heads.

The receiving regions each have preferably a first region and at least one second region, which is directly adjacent to the first region, wherein in each case at least one permanent magnet is inserted into the first region and the second region is in each case filled with fixing compound. In this way, the permanent magnets can be fixed, in particular axially, in a simple manner.

The fixing compound is preferably a plastic or a composite material. In this regard, the plastic may for example be a plastic which is reinforced with fibers, such as for example glass fibers, polyester fibers and/or carbon fibers. In this way, a particularly mechanically stable embodiment of the respective ring can be achieved.

In an advantageous embodiment variant of the present invention, on the end faces of the rotor core, there are formed, in each case in the region of the ring formed from the fixing compound, fixing depressions into which the fixing compound is filled. In this way, additional fixing of the respective ring to the respective end face of the rotor core can be realized.

By means of the design according to the invention of the electric machine, targeted, efficient cooling of winding heads of the stator is achieved in a simple manner. The synergetic utilization of the fixing compound as fixing means for the permanent magnets and as material for formation of a cooling-fluid-distribution ring allows the targeted cooling to be realized in a manner particularly efficient in terms of structural space, assembly and thus costs.

In order to be able to ensure better distribution of the cooling fluid along the winding heads, according to a particularly advantageous configuration of the invention, it may be provided that the ring is closed along a rotor circumference of the rotor, so that the cooling fluid flowing out of the fluid channel can be distributed along a fluid side, directed radially toward the axis of rotation of the rotor, of the ring before the cooling fluid can exit the ring along a fluid course toward the winding heads.

Distribution of the cooling fluid along the fluid side of the ring has the advantage that the cooling fluid can, along its fluid course, exit with greater atomization by way of centrifugal forces of the rotating rotor and be directed to the winding heads. An atomized cooling fluid has a larger surface area and can cover a larger surface area of the winding heads and thereby cool the winding heads more effectively.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows a plan view of an end face of a rotor with a ring.

FIG. 2 shows a detail section view of an electric machine, wherein the section is realized through the rotor along the section plane A-A as per FIG. 1.

FIG. 3 shows a plan view of an end face of a rotor without the ring.

FIG. 4 shows an isometric view of a rotor with the ring.

### DETAILED DESCRIPTION

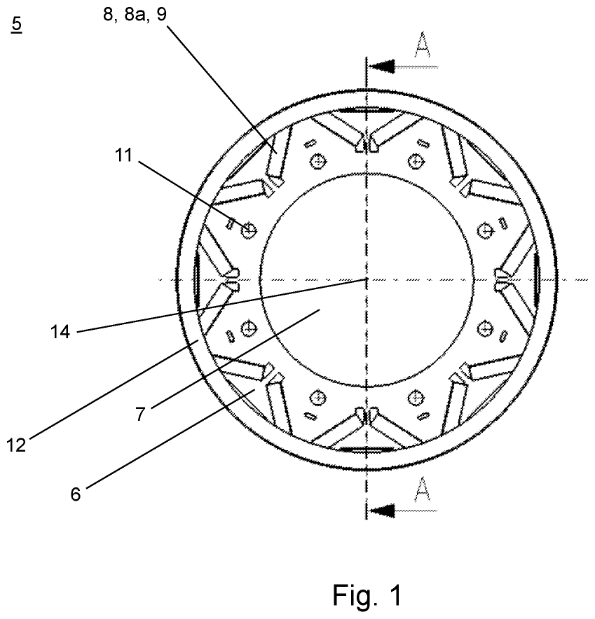

FIG. 1 to FIG. 4 show, in each case schematically, an electric machine 1 according to the invention in different views or degrees of detail.

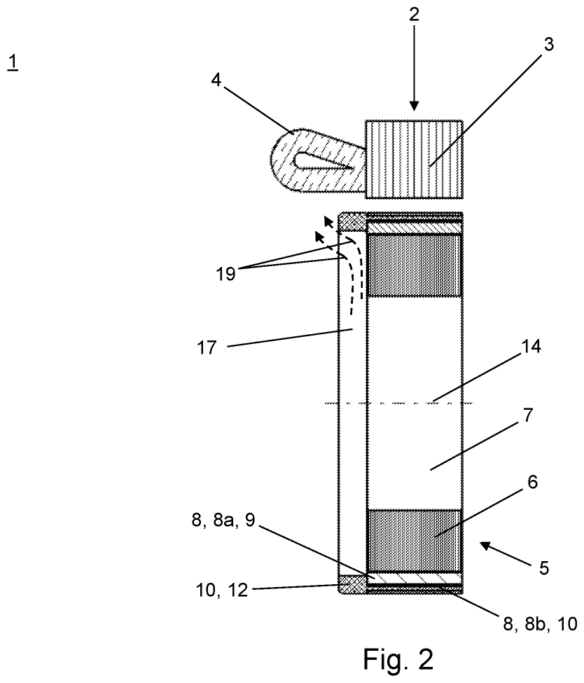

The electric machine 1 includes a fixed stator 2, a rotor 5 mounted rotatably in relation to the stator 2, and a cooling system for cooling the rotor 5 (FIG. 2).

The stator 2 has a stator core 3 on which stator windings are fixed. The stator windings form winding heads 4 on the end faces of the stator core 3 (FIG. 2).

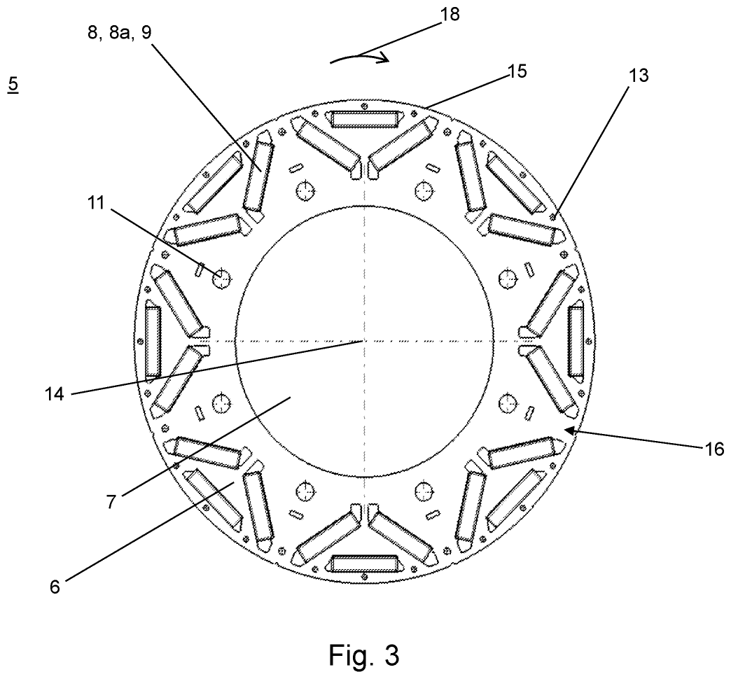

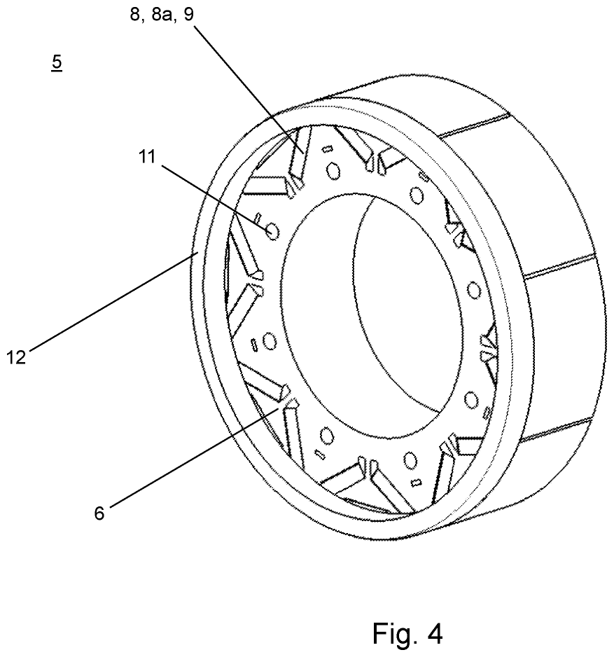

The rotor 5 has a rotor core 6 which is arranged fixedly on a rotor shaft 7 and in which multiple circumferentially uniformly spaced-apart receiving regions 8 are formed (FIG. 1, FIG. 3, FIG. 4). The receiving regions 8, formed in a radially outer region of the rotor core 6, are formed along the axial extent of the rotor core 6.

The directional indication “radial” describes a direction normal to an axis of rotation 14 of the rotor 5 of the electric machine 1. The directional indication “axial” describes a direction along or parallel to the axis of rotation 14 of the rotor 5 of the electric machine 1.

The cooling system has multiple fluid channels 11 via which cooling fluid is able to be guided to the end faces of the rotor core 6 (FIG. 1, FIG. 3, FIG. 4). The fluid channels, formed in a radially inner region of the rotor core 6, are formed along the axial extent of the rotor core 6.

The receiving regions 8 each have a first region 8a and two second regions 8b, which are directly adjacent to the first region 8a, wherein in each case one permanent magnet 9 is inserted in the first regions 8a and the second regions are each filled with fixing compound 10 (FIG. 3).

The fixing compound 10 is at least partially extended axially out of the second regions 8b in such a way that it forms an encircling ring 12 on each of the end faces of the rotor core 6 of the rotor 5 (FIG. 1, FIG. 2, FIG. 4).

This means that, in addition to fixing the permanent magnets 9 in the first regions 8a of the receiving regions 8, the fixing compound 10, through the formation of the rings 12 on the end faces of the rotor core 6, also performs targeted guidance or distribution of cooling fluid to the respective winding heads 4 of the stator 2. Furthermore, through the formation of the rings 12 on the end faces of the rotor core 6, an additional axial fixing of the permanent magnets 9 is also achieved.

If the fixing compound 10 is viewed on its own, that is to say without the rotor core 6, then this forms a cage composed of plastic with rings 12 encircling at the ends, which rings are connected to one another via the axially extending struts that are formed in the second regions 8b by the fixing compound 10.

The ring 12 is shaped in such a way that, during rotation of the rotor 5, the cooling fluid on the end faces of the rotor core 6 is in each case directed toward the winding heads 4 of the stator 2 (FIG. 2).

Furthermore, on the end faces of the rotor core 6 of the rotor 5, there are formed, in each case circumferentially in the region of the ring 12 formed from the fixing compound 10, a multiplicity of fixing depressions 13 into which the fixing compound 10 can flow during formation of the ring 12 and which are accordingly filled with fixing compound 10 (FIG. 3).

FIG. 2 moreover shows that the ring 12 is closed along a rotor circumference 15 of the rotor 5, wherein the ring 12 closes a magnet spacing 16 of the permanent magnets 9 in a region of the rotor circumference 15 in a cooling-fluid-impermeable manner. Accordingly, the ring 12 has a fluid side 17 which is directed radially toward the axis of rotation 14 of the rotor 5, so that, after the cooling fluid has exited the fluid channel 11, it can be at least sectionally uniformly distributed on the fluid side 17 of the ring 12 due to a rotation 18 of the rotor 5.

The rotation 18 of the rotor 5 and the resulting centrifugal forces push the cooling fluid along a fluid course 19 beyond the fluid side 17 of the ring 12 so that the cooling fluid can be atomized and can be guided more uniformly—at any rate in a less jet-like manner—to the winding heads 4. The cooling fluid that is atomized here has a larger surface area and can impinge on the winding heads 4 more uniformly and, accordingly, cool them more effectively.

### LIST OF REFERENCE SIGNS

1 Electric machine
2 Stator
3 Stator core
4 Winding head
5 Rotor
6 Rotor core
7 Rotor shaft
8 Receiving region
8a First region
8b Second region
9 Permanent magnet
10 Fixing compound
11 Fluid channel
12 Ring
13 Fixing depression
14 Axis of rotation (of the rotor)
15 Rotor circumference
16 Magnet spacing
17 Fluid side
18 Direction of rotation
19 Fluid course

What is claimed is:

1. An electric machine comprising:
a fixed stator, wherein the stator includes a stator core on which stator windings are fixed, said stator windings forming winding heads on the end faces of the stator core,
a rotor mounted rotatably in relation to the stator, wherein the rotor includes a rotor core which is arranged fixedly on a rotor shaft, wherein the rotor shaft includes multiple circumferentially uniformly spaced-apart receiving regions formed therein, wherein each receiving region includes one permanent magnet is inserted and fixed therein via a fixing compound,
a cooling system for cooling the rotor, wherein the cooling system includes at least one fluid channel via which cooling fluid is guided to the end faces of the rotor core,
wherein the fixing compound is at least partially formed such that it forms a ring on each of the end faces of the rotor core of the rotor, said ring in each case being shaped such that, during rotation of the rotor, the cooling fluid on the end faces of the rotor core is directed toward the winding heads of the stator.

2. The electric machine as claimed in claim 1, wherein the receiving regions each have a first region and at least one second region, which is directly adjacent to the first region, wherein in each receiving region said case one permanent magnet is inserted into the first region and the second region is filled with said fixing compound.

3. The electric machine as claimed in claim 1, wherein the fixing compound is a plastic or a composite material.

4. The electric machine as claimed in claim 1, wherein, in the region of the respective ring formed from the fixing compound, the end faces of the rotor core include fixing depressions into which the fixing compound is filled.

5. The electric machine as claimed in claim 1, wherein the ring is closed along a rotor circumference of the rotor, such se that the cooling fluid flowing out of the fluid channel is distributed along a fluid side, directed radially toward the axis of rotation of the rotor, of the ring before the cooling fluid can exit the ring along a fluid course toward the winding heads.

6. The electric machine as claimed in claim 1, wherein the ring has a bevel in the direction of the winding heads for directing the cooling fluid toward the winding heads.

7. The electric machine as claimed in claim 5, wherein fluid flows axially past the fluid side of the ring and radially outward past an axial end of the ring in response to centrifugal forces and radially outward toward the stator windings along the fluid course.

8. The electric machine of claim 2, wherein two second regions are disposed adjacent the first region.

9. The electric machine of claim 2, wherein the fixing compound at least partially extends axially out of the at least one second region and forms the ring.

10. The electric machine of claim 9, wherein the respective rings at each end of the rotor core are connected to each other by fixing compound extending axially through the second regions of the rotor core.
